(19) United States
(12) Patent Application Publication
(10) Pub. No.: US 2007/0104021 A1
(43) Pub. Date: May 10, 2007

(54) Screw for plastication of resin material and a plasticizing mechanism

(75) Inventors: Yoshifumi Okabe, Mie (JP); Toshiaki Suzuki, Mie (JP)

Correspondence Address: OLIFF & BERRIDGE, PLC, P.O. BOX 19928, ALEXANDRIA, VA, 22320, US

(73) Assignee: Autonetworks Technologies, Ltd., Mie (JP)

(21) Appl. No.: 10/572,682

(22) PCT Filed: Sep. 22, 2004
(86) PCT No.: PCT/JP04/14318

§ 371 Date: Apr. 28, 2006

(30) Foreign Application Priority Data
Sep. 22, 2003 (JP) 2003-329887
Sep. 16, 2004 (JP) 2004-269857

(51) Int. Cl. B29B 7/42

(52) U.S. Cl. 366/80; 366/88; 366/89

(57) ABSTRACT

To provide a screw for injection molding and a plasticizing device which can ensure downsizing of the plasticizing device by decreasing an L/D ratio as well as keeping a molten resin to be discharged while stably molten and discharged. In the screw 1a, 1b, 1c, the L/D ratio obtained by dividing an effective length L by an external diameter D is 10 or less, and a flight pitch is designed so that a thread length falls within a range of 30 to 300% of a screw with a square pitch having the same diameter and the L/D ratio of 20 to 24. A torpedo plate 13 with a through-hole is installed in the vicinity of the top end of the screw, inside the through-hole arranged is a spindle-shaped torpedo 12 supported by one or more supporting pieces, and between an internal surface of the through-hole and an outer surface of the torpedo 12, formed is a path 17 of plasticized resin material.

### TECHNICAL FIELD

The present invention relates to a screw for plastication of resin material and a plasticizing mechanism for resin material which are employed in an injection molding machine, an extrusion molding machine or the like for obtaining moldings by discharging a plasticized resin material, more specifically relates to a screw for plastication of resin material and a plasticizing mechanism for resin material which are applied to a plasticizing cylinder (heating cylinder), an injection cylinder or the like for an injection molding machine, an extrusion molding machine or the like of small size and are used for making a plastication state of a resin material uniform and discharging the resin material.

### BACKGROUND ART

In a screw for plastication (hereinafter, referred to simply as a “screw”) used in injection molding and extrusion molding of resin material which is installed in a plasticizing cylinder in order to plasticize and discharge a resin material, when an L/D ratio which is obtained by dividing a length L of a section of the screw on an outer surface of which a spiral screw flight is formed (hereinafter, this length is referred to as an effective length L of the screw) by a diameter D of the top end of the screw flight (hereinafter, this diameter is referred to as an external diameter D of the screw) is 10 or less, a plastication state of the resin material is not stabilized generally. Due to this, when using a screw designed to have such an L/D ratio, unmolten resin or half-molten resin is discharged from a plasticizing cylinder or an injection cylinder, causing incompleteness or infeasibility in molding.

In order to prevent incompleteness or infeasibility in molding, for example, a screw designed to have the L/D ratio of 24 is used for wire covering and a screw designed to have the L/D ratio of 18 to 20 is used for injection molding. With such L/D-ratio design, even though the external diameter D of the screw is set to be about 20 mm for example, the effective length L thereof becomes about 480 mm in the case of the screw for wire covering and becomes 360 mm or more in the case of the screw for injection molding. In this way, the effective length L and the entire length of the screw cannot be decreased even by making the external diameter D of the screw smaller, and accordingly, it is difficult to achieve downsizing of an injection molding machine or an extrusion molding machine.

As a configuration which achieves compatibility between decrease in length of the screw and stable feeding of the resin material in a uniform plastication state, proposed are configurations, for example, such that the effective length L of the screw is decreased while the external diameter D is enlarged and large-scale shear between an internal surface (heating surface) of the plasticizing cylinder and an outer surface (plasticizing surface) of the screw is generated to plasticize the resin material (see Japanese Patent Application Unexamined Publication No. Hei 6-312443), and such that the temperature is controlled by a temperature controller installed on an outer surface of the plasticizing cylinder while the L/D ratio of the screw is set to be 1 to 3 (see Japanese Patent Application Unexamined Publication No. 2000-71252). In addition to the above-described configurations, proposed is a configuration such that a screw in a cone shape is employed (see Japanese Patent Application Unexamined Publication No. 2002-67110).

The configurations described in the above-mentioned references are for ensuring stabilization of a plastication state of the resin material by employing a screw of large diameter or in a cone shape in order to increase an area providing the resin material with shear to promote plastication by heat generated by shear. Employing the screw of large diameter can decrease the effective length of the screw; however, it does not always decrease an occupied volume thereof. In addition, in order to drive the screw of large diameter, it is required to upsize a driving system such as a motor. Due to this, it is difficult to ensure downsizing of the injection molding machine, the extrusion molding machine or the like. In addition, it is relatively hard to fabricate a screw in a cone shape and a cylinder in a cone shape so as to be in combination.

In addition, a widely employed configuration for promoting plastication of the resin material is such that a barrier flight or a sub flight is formed, a Dulmage structure is provided, a shear element is provided, or the number of threads is increased. However, a screw having a well-known kneading structure such as a shear element and a screw on which a plurality of threads are formed generally have a disadvantage that a discharge rate or measurement is difficult to stabilize at the time of continuous discharge compared with a full flight screw. Additionally, in such a configuration, it is necessary to employ an appropriate screw in accordance with the variety of resin materials so that discharge can be made under optimum conditions. Employing such a screw takes a lot of troubles with maintenance and replacement; therefore it is not considered that the configuration is favorable for the use at actual manufacturing premises.

Further, also employed is a configuration such that a spindle-shaped member called a torpedo (also called a spreader) is installed in the vicinity of an end of the plasticizing cylinder. This configuration is for ensuring stabilization of a plastication state of the resin material by decreasing a cross sectional area of a flow path of the plasticized resin material in order to develop a shear rate of the resin material to promote heat generation by shear. For example, a configuration is proposed such that a material consisting of a powder of a cellulosic material and a resin are fed into a resin reservoir formed between the screw and the torpedo using the screw and the screw is made to run forward to inject a molten resin through the flow path formed between the torpedo and a barrel (see Japanese Patent Application Unexamined Publication No. Hei 11-198164).

However, though the Publication JP Hei 11-198164 describes well-known arts in which a resin is plasticized by heat generated by shear and the shape of flutes of the torpedo is changed to adjust a surface appearance and a touch of the plasticized resin, structures how to support and mount the torpedo are not clearly described. In addition, the screw employed therein is described as a short and specific one; however, the extent of a difference between its L/D ratio and the L/D ratio of 18 to 20 which is for general injection molding or a concrete structure of the screw is not disclosed.

Consequently, the present invention has been made in view of the above circumstances and has an object to overcome the above problems and to provide a screw for plastication of resin material and a plasticizing mechanism for resin material which ensure downsizing of an injection molding machine, an extrusion molding machine or the like by decreasing the L/D ratio without extremely enlarging the screw in external diameter and ensure compatibility between maintenance of a uniform plastication state of a resin material and stability of discharge of a plasticized resin material even in the case of a short screw.

### DISCLOSURE OF THE INVENTION

To achieve the objects and in accordance with the purpose of the present invention, the invention described in claim 1 is intended to provide a screw for plastication of resin material installed in a plasticizing cylinder for plasticizing a resin material for molding, wherein an external diameter D of a metering section formed at a top part of the screw is 100 mm or less, an L/D ratio obtained by dividing a length L of a section of the screw on an outer surface of which a spiral screw flight is formed by the external diameter D of the metering section is 10 or less, and a pitch of the screw flight is designed so that a thread length thereof falls within a range of 30 to 300% of a thread length of a screw in which an L/D ratio is 20 to 24 and a pitch of a screw flight is designed to be the same as an external diameter D of a metering section.

Further in the screw for plastication of resin material, as described in claim 2, it is desirable that an external diameter of a feed section for feeding the resin material into the plasticizing cylinder is designed to be larger than the external diameter of the metering section for keeping an extrusion amount of the resin material uniform and an external diameter of a compression section for plasticizing the resin material, and a channel depth of the feed section formed by the screw flight is designed to be larger than a channel depth of the compression section.

Further in the screw for plastication of resin material, as described in claim 3, it is desirable that a pitch of the screw flight in the feed section for feeding the resin material into the plasticizing cylinder is designed to be larger than a pitch of the screw flight in the metering section for keeping the extrusion amount of the resin material uniform and smaller than the external diameter of the metering section and a pitch of the screw flight in the compression section for plasticizing the resin material is designed to become smaller gradually from the feed section toward the metering section, and furthermore, as described in claim 4, it is desirable that the pitch of the screw flight in the feed section for feeding the resin material into the plasticizing cylinder is designed to be more than 1.5 times as large as the pitch of the screw flight in the metering section for keeping the extrusion amount of the resin material uniform.

In addition, the invention described in claim 5 is intended to provide a plasticizing mechanism for resin material, wherein the screw for plastication of resin material according to any of claims 1 to 4 is installed in the plasticizing cylinder for plasticizing the resin material, and a torpedo plate in which a torpedo is supported so as to be positioned in a central part of a path of the resin material is arranged to be mountable and demountable at a downstream part of a flow of the resin material in the plasticizing screw and the resin material inside the plasticizing cylinder is conveyed to flow around the torpedo in the torpedo plate.

When the flight pitch is designed so that the thread length of the screw is 30 to 300% of the thread length of the screw of the same diameter in which the L/D ratio is designed to be 20 to 24 and the flight pitch is designed to be the same as the external diameter D of the metering section (hereinafter, the screw designed as such is referred to as a screw with a square pitch) as in the invention described in claim 1, the thread length can be secured to be long even in the case of the L/D ratio of 10 or less.

The long thread length increases a distance in the plasticizing cylinder where the resin material is sheared and also increases a residence time of the resin material in the plasticizing cylinder if the number of revolutions of the screw is the same as before, increasing heating time, and thereby the plastication of the resin material is promoted. In addition, a discharge rate decreases in the case of the same revolution number as before; accordingly, when the revolution number is increased to keep the discharge rate, a greater sharing force is applied to the resin material, and thereby the plastication is promoted. Thus, a plastication state of the resin material can be stabilized while the external diameter D of the screw is not extremely enlarged; therefore compatibility is ensured between the stabilization of the plastication state of the resin material and downsizing of an injection molding machine or an extrusion molding machine.

When the external diameter of the feed section for feeding the resin material is enlarged compared with that of the metering section for metering the resin material as in the invention described in claim 2, the channel depth of the feed section can be enlarged. Owing to this, a sufficient amount of resin material can be fed even though the flight pitch of the feed section cannot be enlarged enough compared with a pellet size of the resin material. Then, in the compression section, the external diameter of the screw is gradually decreased, so that compression brought by decrease in spatial volume between the screw threads is also applied to the resin material. Therefore, plastication of the resin material is rapidly achieved even in the case of a short screw, allowing stabilization of a plastication state of the resin material.

When the flight pitch of the feed section is formed to be larger than that of the metering section as in the invention described in claim 3, a feed rate of the resin material fed into the plasticizing cylinder can be sufficiently secured in the feed section, and the resin material can be fed stably. Then, the smaller channel depth of the compression section as well as the gradual decrease in the flight pitch thereof apply compression to the resin material. Therefore, plastication of the resin material is rapidly achieved even in the case of a short screw, allowing stabilization of a plastication state of the resin material.

When the flight pitch of the feed section is more than 1.5 times as large as that of the metering section as described in claim 4 and is not larger than the external diameter of the screw in the metering section, the thread length of the screw can be secured for stabilization of a plastication state while the resin material in the feed section can be fed stably.

Here, owing to the plasticizing mechanism employing the above-described screw in combination with a configuration that the torpedo plate including the torpedo is installed in the vicinity of the top end of the screw in the plasticizing cylinder as described in claim 5, further stabilization of a plastication state of the resin material to be discharged can be ensured without incurring complexity of a structure or a driving mechanism of the screw nor upsizing of an injection molding machine. In addition, as the torpedo plate is made exchangeable, injection of the resin material can be achieved under optimum conditions. Therefore, there arises no need to prepare a plurality of screws in accordance with the variety of resin materials, allowing costs for equipment to be curbed.

### BRIEF DESCRIPTION OF THE DRAWINGS

FIGS. 1A to 1C are external plan views showing structures of screws consistent with the first embodiment of the present invention, and the screw shown in FIG. 1A is designed to have the external diameter D of 22 mm and a flight pitch of 11 mm, the screw shown in FIG. 1B is designed to have the external diameter D of 22 mm and a flight pitch of 8 mm, and the screw shown in FIG. 1C is designed to have the external diameter D of 22 mm and a flight pitch of 22 mm;

FIGS. 2A and 2B are plan views diagrammatically showing structures of screws consistent with the second embodiment of the present invention and states in which the screws are installed in plasticizing cylinders, and the screw in FIG. 2A has a large root diameter in a feed section and the screw in FIG. 2B has a small root diameter in a feed section;

FIG. 3A is an external plan view showing a structure of a screw consistent with the third embodiment of the present invention, and FIG. 3B is a view showing a conventional example for the sake of comparison;

FIG. 4A is an external perspective view showing an exploded state of a plasticizing cylinder in which a plasticizing mechanism for resin material consistent with the present invention is installed, and FIG. 4B is a front view of a torpedo plate which is installed in the plasticizing cylinder; and

FIG. 5 is a sectional view showing a structure of the plasticizing cylinder in which the above-described plasticizing mechanism for resin material is installed.

### BEST MODE FOR CARRYING OUT THE INVENTION

A detailed description of one preferred embodiment of the present invention will now be given with reference to the accompanying drawings.

While the type of a resin material to which a screw consistent with the present invention is applicable is not limited, the screw is favorably applicable especially to a polybutylene telephthalate (PBT) resin, a polypropylene (PP) resin, a commonly-used thermoplastic elastomer material and the like. In addition, a pellet of commercially available size and shape, for example, one which is 3 mm in diameter and 2 mm in length is applicable.

For the use on a common office desk, it is preferable for the screw to have the external diameter of about 90 mm or less, and in order to apply to a small-size plasticizing device, it is more preferable for the screw to have the external diameter of 60 mm or less. Hence, inorder that the screw may also be used for such purposes, to the screw consistent with the present invention, one having the external diameter of about 100 mm or less, specifically about 90 mm or less is favorably applied. Here, an L/D ratio is obtained by dividing an effective length L of a screw by an external diameter D thereof. When the screw is designed to have the L/D ratio of 10 or less (e.g., the L/D ratio of 5 or 10), a flight pitch is designed so that a thread length of the screw falls within a range of about 30 to 300% (hereinafter, this range is sometimes referred to as a “preferable range”), more preferably a range of about 60 to 150% (hereinafter, this range is sometimes referred to as a “more preferable range”) of a thread length of a screw with a square pitch having the same diameter and the L/D ratio of 20 to 24. With such design, compatibility between maintenance of a favorable plastication state of the resin material and downsizing of an injection molding machine brought by downsizing of the screw is ensured.

In other words, according to the screw in which the flight pitch is adjusted so that the thread length falls within 30 to 300% of the thread length of the screw with a square pitch having the same diameter and the L/D ratio of 20 to 24, when the number of revolutions of the screw is made the same as before, a discharge rate per revolution decreases; therefore, a residence time of the resin material becomes about 70 to 700% in comparison as before to show that the resin material is allowed to stay for the same period of time as or longer than before. Generally, it is said that a main heat source for rapid plastication of the resin material in a plasticizing cylinder is heat generated by shear in the resin material. However, heat applied to the plasticizing cylinder also brings about plastication of the resin material, not as rapid as the plastication by heat generated by shear. Accordingly, when the resin material is allowed to stay more time in the plasticizing cylinder, the resin material is plasticized by heat generated by shear and heat applied to the plasticizing cylinder without leaving a half-molten resin or an unmolten resin, allowing stabilization in the plastication state of the resin material.

Meanwhile, when the flight pitch is made smaller, the discharge rate of the plasticized resin material per revolution of the screw decreases, so that it is necessary to raise the revolution number of the screw to secure the discharge rate of the resin material. When the revolution number of the screw is raised in order to maintain the discharge rate as same as before, a large-scale shearing force is applied to the resin material to bring about easier plastication, allowing stabilization in the plastication state of the resin material.

Therefore, according to the screw having the L/D ratio designed as described above, an entire length of the screw can be decreased without a necessity to extremely enlarge the screw in external diameter while maintaining the favorable plastication state of the resin material. Owing to the downsizing or the decrease in length of the screw, an injection molding machine or an extrusion molding machine can be downsized. Therefore, the compatibility is achieved between the stabilization of the plastication state of the resin material to be discharged and the downsizing of an injection molding machine or an extrusion molding machine.

Table 1 in the following shows: results of calculation of thread lengths and flight pitches of screws having the L/D ratio of 5 or 10 and the external diameter D of 22 mm, the screws being consistent with the first embodiment of the present invention; comparisons of the thread lengths of the screws with a thread length of a screw with a square pitch having the L/D ratio of 20; and assessments of plastication states of resin materials in cases where the respective screws are used.

TABLE 1

| | | | | | Ratio | |
|---|---|---|---|---|---|---|
| | | | | | of | Assessment |
| | External | | Number | Thread | Thread | of |
| | Diameter | Pitch | of | Length | Length | Plastication |
| L/D | mm | mm | Pitch | mm | % | State |
| L/D = 20 | 22 | 22 | 20.0 | 1551.39 | 100.0 | ⊚ |
| L/D = 10 | 22 | 22 | 10.0 | 775.70 | 50.0 | ◯ |
| L/D = 10 | 22 | 11 | 20.0 | 1424.62 | 91.8 | ⊚ |
| L/D = 10 | 22 | 8 | 27.5 | 1929.98 | 124.4 | ⊚ |
| L/D = 10 | 22 | 5 | 44.0 | 3413.06 | 220.0 | ◯ |
| L/D = 5 | 22 | 22 | 5.0 | 387.85 | 25.0 | X |
| L/D = 5 | 22 | 11 | 10.0 | 712.31 | 45.9 | ◯ |
| L/D = 5 | 22 | 8 | 13.8 | 964.99 | 62.2 | ⊚ |
| L/D = 5 | 22 | 5 | 22.0 | 1528.91 | 98.6 | ⊚ |

The assessments were made respectively as to a polybutylene telephthalate resin and a polypropylene resin. For a pellet, one which is 3 mm in diameter and 2 mm in length was used. Besides, no filler was used. The revolution number of the screws was set in a range of 150 to 360 rpm. In addition, the plastication cylinders were heated using a heater. Heating temperatures by the heater were set to be 300 to 360° C. in the case of the polybutylene telephthalate resin and 200 to 280° C. in the case of the polypropylene resin.

In the item “Assessment of Plastication State” in Table 1, “⊚” indicates a plastication state in which the resin material is completely plasticized and there arises no problem in injection molding, “∘” indicates a plastication state in which the resin material is plasticized while the temperature becomes slightly unstable, and “X” indicates a unfavorable plastication state in which the resin material is sometimes mixed with the not-completely plasticized one.

Besides, the screw in the top row in Table 1 having the L/D ratio of 20, the external diameter of 22 mm and the pitch of 22 mm is a conventionally-designed screw, which is provided for comparison purposes.

Firstly, a description is given to the screw designed to have the L/D ratio of 10. As shown in Table 1, when the flight pitch is designed to be 22 mm , the thread length becomes 50% of that of the screw having the L/D ratio of 20. When the flight pitch is designed to be 11 mm , the thread length becomes 92% of that of the screw having the L/D ratio of 20. When the flight pitch is designed to be 8 mm , the thread length becomes 125% of that of the screw having the L/D ratio of 20. When the flight pitch is designed to be 5 mm , the thread length becomes 220 mm of that of the screw having the L/D ratio of 20. By designing the flight pitches in this manner, each of the thread lengths can be adjusted to fall within the range of 30 to 300% being the “preferable range”.

As for the plastication states of the resin materials, when the screw in which the flight pitch is designed to be 11 mm or 8 mm was used, the respective resin materials were completely plasticized to bring about a state where there is no problem with injection molding. These screws have the thread lengths which fall within the “more preferable range”, i.e., the range of 60 to 150 mm of the thread length of the screw having the L/D ratio of 20. In addition, when the screw in which the flight pitch is designed to be 22 mm or 5 mm was used, the resin materials were plasticized. These screws have the thread lengths which fall within the range of 30 to 300% of the thread length of the screw having the L/D ratio of 20 (i.e., the “preferable range”) but fall outside the “more preferable range”.

Next, a description is given to the screw designed to have the L/D ratio of 5. When the flight pitch is designed to be 11 mm , the thread length becomes 45.9% of that of the screw having the L/D ratio of 20. When the flight pitch is designed to be 8 mm , the thread length becomes 62% of that of the screw having the L/D ratio of 20. When the flight pitch is designed to be 5 mm , the thread length becomes 98% of that of the screw having the L/D ratio of 20. By designing the flight pitches in this manner, the thread lengths can be adjusted to fall within the “preferable range”. However, if the flight pitch is designed to be 22 mm , the thread length becomes 25% of that of the screw having the L/D ratio of 20, falling outside the “preferable range”.

As for the plastication states of the resin materials, when the screw in which the flight pitch is designed to be 8 mm or 5 mm was used, the respective resin materials were completely plasticized to bring about a state where there is no problem with injection molding. These screws have the thread lengths which fall within the “more preferable range”. In addition, when the screw in which the flight pitch is designed to be 11 mm was used, the resin material was plasticized. This screw has the thread length which falls within the “preferable range” but falls outside the “more preferable range”. On the other hand, when the screw in which the flight pitch is designed to be 22 mm was used, the plastication state of the resin material was unfavorable where the plasticized resin material was mixed with a not-completely plasticized resin material. This screw has the thread length which falls outside the “preferable range”.

As described above, for the screws having the L/D ratio of 10, in order to have the thread length fall within the “preferable range”, the flight pitch may be designed to be any of 5 mm, 8 mm, 11 mm and 22 mm. However, in order to have the thread length fall within the “more preferable range”, it is preferable to design the flight pitch to be 8 mm or 11 mm. Meanwhile, for the screws having the L/D ratio of 5, in order to have the thread length fall within the “preferable range”, it is preferable to design the flight pitch to be 5 mm, 8 mm or 11 mm, and in order to have the thread length fall within the “more preferable range”, it is preferable to design the flight pitch to be 5 mm or 8 mm.

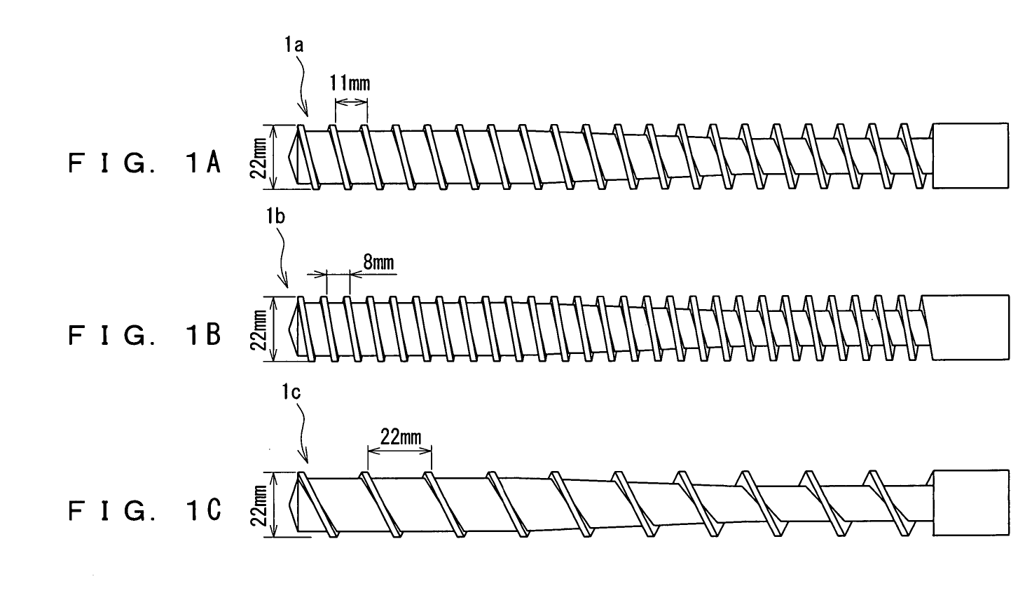

FIGS. 1A, 1B and 1C are external plan views showing structures of the screws designed to have the L/D ratio of 10 among the examples shown in Table 1. A screw la in FIG. 1A has a flight pitch of 11 mm and a thread length of 92% of that of the screw with a square pitch having the L/D ratio of 20. A screw 1b in FIG. 1B has a flight pitch of 8 mm and a thread length of 125 mm of that of the screw with a square pitch having the L/D ratio of 20. In this way, these screws la and 1b respectively have the thread lengths which fall within the “more preferable range”. A screw 1c in FIG. 1C has a flight pitch of 22 mm and a thread length of 50% of that of the screw with a square pitch having the L/D ratio of 20. That is, the screw 1c is an example of the screw which has the thread length falling within the “preferable range” but falling outside the “more preferable range”.

Incidentally, the “preferable range” of the thread length of the screw consistent with the present embodiment is 30 to 300% of that of the screw with a square pitch having the same diameter and the L/D ratio of 20 or 24; however, it changes depending on an amount of a filler of the resin material. Additionally, in order to ensure further stabilization of the plastication state of the resin material, another configuration may be employed where various well-known structures which promote plastication of the resin material are additionally provided or used in combination: for example, a barrier flight or a sub flight is formed on the screw, a Dulmage structure or a shear element is provided in the screw, or the thread number is increased.

In addition, the applicable resin material is not limited to the polybutylene telephthalate resin and the polypropylene resin mentioned above, and a resin material which is plasticized at temperatures in the above-mentioned ranges is applicable. For example, polyamide, polyphthalamide and a syndiotactic polystyrene (SPS) resin are cited.

Next, a description is given to screws consistent with the second embodiment of the present invention. The screws consistent with the present embodiment are formed so that channel depths of feed sections are made larger than those of metering sections, so that feed rates of the resin materials in the feed sections can be secured sufficiently. Besides, thread lengths and flight pitches of the screws consistent with the present embodiment are designed the same as those consistent with the first embodiment.

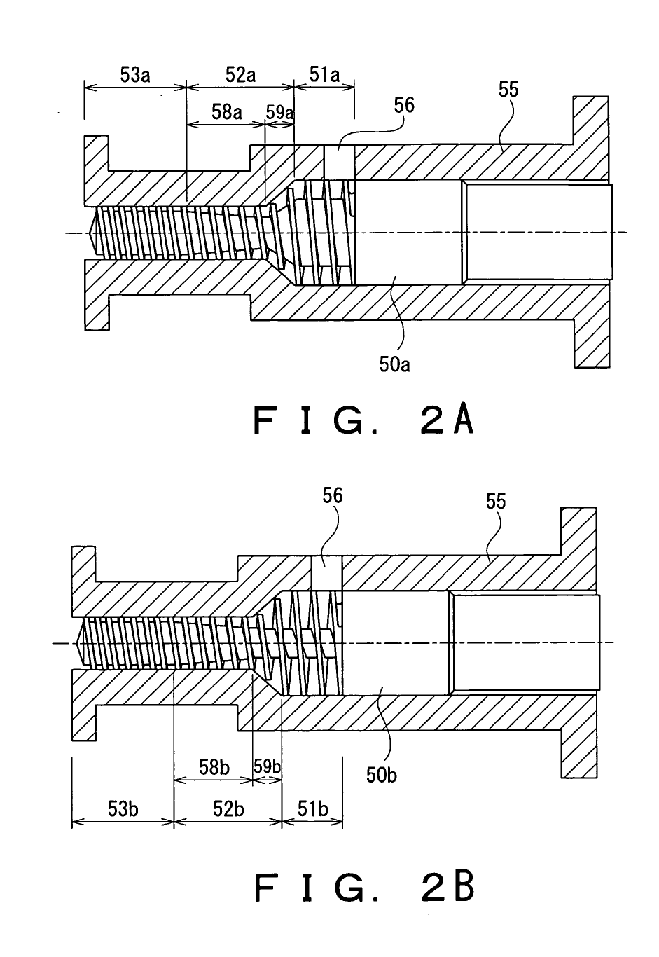

FIGS. 2A and 2B are sectional views diagrammatically showing specific shapes of the screws consistent with the present embodiment and states in which the screws are installed in plasticizing cylinders. Besides, the plasticizing cylinders are shown in section while outward appearances are shown regarding the screws. In addition, the screws are shown while enlarged radially in order to easily discern differences between external diameters and root diameters of the screws (in the present specification, a root diameter is referred to as a diameter which is obtained by subtracting the channel depth from the external diameter of the screw), so that the screws shown are different in shape from the actual ones.

Screws 50a and 50b in FIGS. 2A and 2B are formed so that feed sections 51a and 51b are larger than metering sections 53a and 53b in external diameter. The screw 50a in FIG. 2A is formed so that the feed section 51a is larger than the metering section 53a and a compression section 52a in root diameter. The screw 50b in FIG. 2B is formed so that the feed section 51b is smaller than the metering section 53b and a compression section 52b in root diameter. Besides, a plasticizing cylinder 55 is formed so that an internal surface thereof fits the external diameters of the respective sections of the screw.

A detailed description is given to these screws 50a and 50b. As for the screw 50a shown in FIG. 2A, the feed section 51a is formed to have a uniform external diameter and a uniform root diameter to provide cylindrical shapes. A section 59a of the compression section 52a, which is closer to the feed section 51a, has an external diameter and a root diameter both of which are narrowed gradually from the feed section 51a toward the metering section 53a. The narrowed volume of the external diameter is greater than that of the root diameter, so that a channel depth becomes smaller gradually toward the metering section 53a. In addition, a section 58a of the compression section 52a, which is closer to the metering section 53a, has a uniform external diameter to provide a cylindrical shape while having a root diameter which becomes larger gradually toward the metering section 53a. Accordingly, a channel depth of the compression section 52a becomes smaller gradually toward the metering section 53a. The metering section 53a is formed to have a uniform external diameter and a uniform root diameter to provide cylindrical shapes.

As for the screw 50b shown in FIG. 2B, the feed section 51b is formed to have a root diameter smaller than that of the metering section 53b. The feed section 51b and the metering section 53b are formed to have the uniform root diameters to provide cylindrical shapes. A section 59b of the compression section 52b, which is closer to the feed section 51b, is formed to have a root diameter the same as that of the feed section 51b to provide a cylindrical shape. A section 58b of the compression section 52b, which is closer to the metering section 53b, is formed to have a root diameter which becomes larger gradually from the section 59b closer to the feed section 51b toward the metering section 53b forming a tapered shape, smoothly connecting the section 59b closer to the feed section 51b and the metering section 53b.

The feed section 51b and the metering section 53b are formed to have uniform external diameters to provide cylindrical shapes. In addition, the feed section 51b is formed to have the external diameter larger than that of the metering section 53b. The section 59b of the compression section 52b, which is closer to the feed section 51b, has an external diameter which is narrowed gradually from the feed section 51b toward the metering section 53b. Meanwhile, the section 58b of the compression section 52b, which is closer to the metering section 53b, is formed to have a uniform external diameter, which is the same as that of the metering section 53b.

When the channel depths of the feed sections 51a and 51b are larger than those of the compression sections 52a and 52b and those of the metering sections 53a and 53b as described above, the feed rates of the resin materials in the feed sections 51a and 51b can be secured sufficiently. Additionally, when the channel depths of the compression sections 52a and 52b are formed to become smaller gradually from the feed sections 51a and 51b toward the metering sections 53a and 53b, the resin materials are compressed to promote plastication. Therefore, compatibility between decrease in length of the screws and stabilization of a discharge state of the resin material can be achieved.

Next, a description is given to the third embodiment of the present invention. Plasticizing screws consistent with the present embodiment are formed so that a flight pitch of a feed section is larger in order to stabilize the feed rate of the resin material in the feed section. Then, a flight pitch of the compression section is formed to become smaller gradually toward the metering section to compress the resin material. Accordingly, the screws, even short, can achieve rapid plastication of the resin material. Besides, thread lengths of the screws are designed the same as those consistent with the first embodiment.

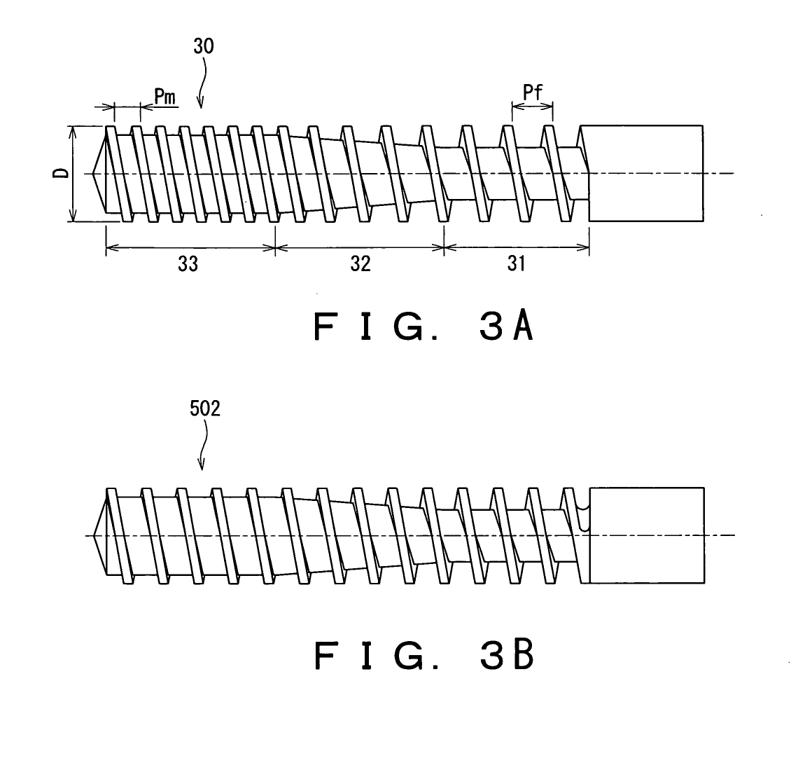

FIG. 3A is an external plan view showing a structure of the screw consistent with the third embodiment. A screw 30 shown in FIG. 3A is designed to have the L/D ratio of 5. Besides, a screw 502 shown in FIG. 3B is a comparative example. On the screw 502 in FIG. 3B, a flight pitch is formed uniformly over its entire effective length.

The screw 30 of the present embodiment is formed so that an external diameter is uniform over its entire effective length to provide a cylindrical shape. A feed section 31 and a metering section 33 are formed to have uniform root diameters to provide approximately cylindrical shapes. Besides, the metering section 33 is formed to have the root diameter larger than that of the feed section 31. In addition, in a compression section 32, a root diameter at an end close to the feed section 31 is the same as that of the feed section 31 and a root diameter at an end close to the metering section 33 is the same as that of the metering section 33, and the root diameter of the compression section 32 is arranged to become larger gradually from the end close to the feed section 31 toward the end close to the metering section 33.

Then, with the thread length of the screw within the “preferable range”, a flight pitch P_{f} of the feed section 31 is designed to be larger than a flight pitch Pₘ of the metering section 33. Especially, it is desirable that the flight pitch P_{f} of the feed section 31 is designed to be more than 1.5 times as large as the flight pitch Pₘ of the metering section 33 and smaller than the diameter D of the metering section 33. In addition, a flight pitch of the compression section 32 becomes smaller gradually from the end close to the feed section 31 toward the end close to the metering section 33, smoothly connecting the screw flights of the feed section 31 and the metering section 33.

Incidentally, for smooth connection of the screw flights at the boundary between the metering section 33 and the compression section 32, there emerges a need to form such a section also in the metering section 33 that the flight pitch becomes smaller toward an end of the screw. Due to this, the flight pitch of the metering section 33 becomes nonuniform; it is therefore desirable to have the flight pitch uniform by four pitches from the end of the metering section 33, and it is more desirable to have it uniform by six pitches. With such design, stable discharge of the plasticized resin material can be achieved.

As described above, when the flight pitch P_{f} of the feed section 31 is made larger, a stable feed rate of the resin material in the feed section 31 is allowed. To the compression section 32, compression brought by the smaller flight pitch is applied in addition to compression brought by a smaller channel depth, allowing rapid plastication of the resin material even the screw 30 is short. As the flight pitch Pₘ of the metering section 33 is formed uniform, the stable discharge of the plasticized resin material can be achieved. Therefore, compatibility between the decrease in length of the screw and the stabilization of a plastication state and a discharge state of the resin material to be discharged can be achieved.

Next, a description is given to a plasticizing mechanism for resin material used favorably in combination with the respective screws above described. According to the respective screws having the above-described configurations, the screws can be shortened while stabilizing the plastication state of the resin material. However, the resin material sometimes becomes difficult to plasticize because of excessive addition of a filler to the resin material, and the like. In addition, when the screw is designed to have the thread length fall within the “preferable range”, the flight pitch of the feed section may sometimes become excessively small depending on the pellet size of the employed resin material or the number of the threads provided to the screw, possibly causing difficulties in securing the feed rate of the resin material as well as difficulties in setting the thread length to fall within the “preferable range”.

In such cases, the various well-known configurations to promote plastication of the resin material can be added. Specifically cited is the configuration, as mentioned above, such that the barrier flight or the sub flight is formed on the screw, such that the Dulmage structure or the shear element is provided, or such that the number of threads is increased. The plasticizing mechanism for resin material consistent with the present invention is applied in addition to, or instead of such a configuration. Specifically, the plasticizing mechanism for resin material is configured such that a torpedo plate for promoting plastication of the resin material is installed ahead of the screw in the plasticizing cylinder, i.e., at a downstream part of a flow of the plasticized resin material.

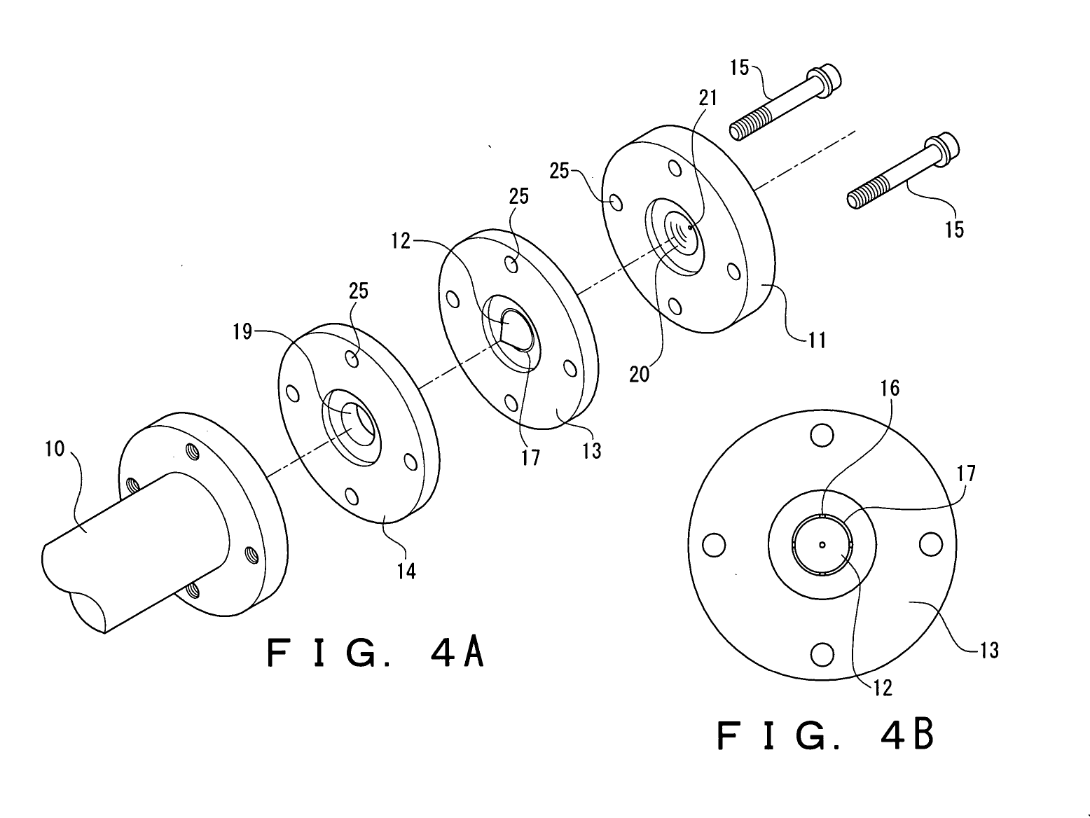

FIG. 4A is an external perspective view showing an exploded state of one end of the plasticizing cylinder in which the plasticizing mechanism of the present invention is incorporated. As shown in FIG. 4A, to one end of a plasticizing cylinder 10, a cylinder head 11, a torpedo plate 13 in which a torpedo 12 is arranged, and a spacer 14 are piled to be fixed.

The torpedo plate 13 has a configuration such that a through-hole is formed at the approximate center of a plate-shaped member and the torpedo 12 approximately spindle-shaped is arranged inside of the through-hole. Here, FIG. 4B is an external plan view of the torpedo plate 13. As shown in FIG. 4B, the torpedo 12 is supported by one or more fins (supporting pieces) 16. Besides, in FIG. 4B, a configuration in which four fins support is shown as an example. Between an outer surface of the torpedo 12 and an internal surface of the through-hole, a path 17 of molten resin is formed like a clearance.

The spacer 14 is a plate-shaped member similar to the torpedo plate 13, at the approximate center of which formed is a path 19 of resin material being a through-hole. Besides, for the purpose of smooth flow of the plasticized resin material, it is desirable for the path 19 of resin material to have the caliber approximately the same as the diameter of the through-hole formed in the torpedo plate 13.

In the cylinder head 11, in order not to interfere with the torpedo 12, a concave part 20 is formed at the approximate center on a surface mated to the torpedo plate 13. At the center of the concave part 20, formed is a path 21 of resin material being a through-hole of which the caliber is smaller than the paths 17 and 19 of resin material of the torpedo plate 13 and the spacer 14. Accordingly, at the center of the cylinder head 11, formed is a through-hole which is cross-sectionally in a funnel shape as a whole.

At the one end of the plasticizing screw 10, the spacer 14, the torpedo plate 13 and the cylinder head 11 are piled to be installed in this order from a part closer to the plasticizing screw 10, and they are fixed to the one end of the plasticizing screw 10 with bolts 15 via bolt holes 25 formed in the respective members.

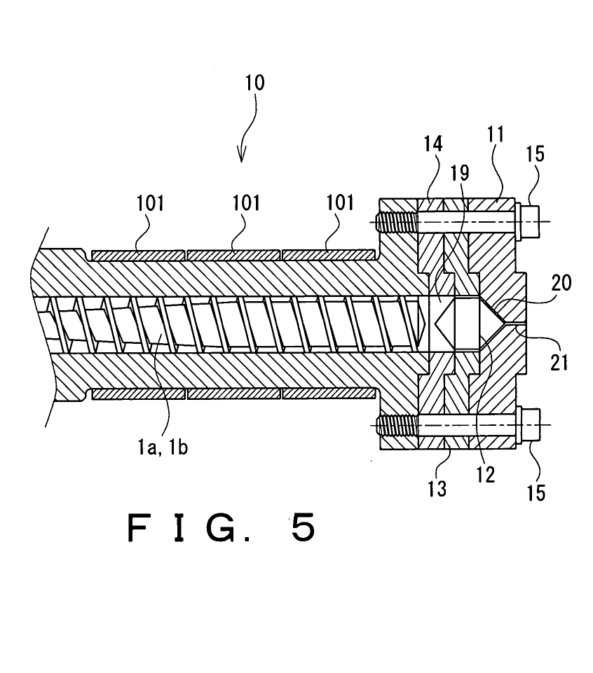

FIG. 5 is a sectional view showing a state in which the plasticizing mechanism for resin material consistent with the present invention is incorporated. Besides, in FIG. 5, the screw 1a, 1b and the torpedo 12 are shown in an external view, not in a sectional view. In the state of incorporation, a part of the torpedo 12 which projects from a circular-plate-shaped surface of the torpedo plate 13 is accommodated in the concave part 20 of the cylinder head 11 with a predetermined clearance in order to be kept from contact therewith. Meanwhile, a part of the torpedo 12 which projects toward the screw 1a, 1b is fixed using the spacer 14 at a position such that the part does not interfere with the screw 1a, 1b. Additionally, heaters 101 for heating the resin material are sometimes installed on an outer surface of the plasticizing cylinder 10.

According to such a configuration, the plasticized resin material conveyed from the plasticizing cylinder 10 flows through the path 17 of resin material of the torpedo plate 13 and the clearance between the outer surface of the torpedo 12 and an internal surface of the concave part 20 of the cylinder head 11. Then, the resin material is conveyed from the path 21 of resin material of the cylinder head 11 to a nozzle and the like (not illustrated) mounted to the cylinder head 11, and discharged.

Incidentally, the torpedo 12 arranged in the torpedo plate 13 does not always have to be formed in such a manner that one end or both ends thereof project from an end surface/end surfaces of the torpedo plate 13. For example, the configuration may be arranged such that the torpedo plate 13 is made thicker in order that the torpedo 12 does not interfere with the screw 1a, 1b without the use of the spacer 14.

In addition, when a screen member for removing foreign particles (e.g., a mesh plate material such as a stainless-steel wire gauze) needs to be installed to remove foreign particles mixed in the resin material, the configuration may be arranged in such a manner that a breaker plate is inserted either in front of or behind the torpedo plate 13 in order to hold the screen member.

As described above, at the time of continuous discharge using the above-described short screw having the L/D ratio of 10 or less, especially using the screw having the L/D ratio of 5 or less, employing such a configuration that the torpedo plate in which the torpedo is arranged is installable in the plasticizing cylinder and improving the plastication state of the resin material using the torpedo plate do not result in complexity or upsizing of a driving mechanism of the screw. Therefore, further stabilization of the plastication state of the resin material can be ensured while keeping an injection molding machine or an extrusion molding machine small.

In addition, the shape of the torpedo 12, an area of the flow path such as the clearance between the torpedo 12 and the through-hole, surface finishing of the torpedo plate 13, and the number and shape of the fins (supporting pieces) 16 for supporting the torpedo 12 vary depending on the resin to be discharged. Therefore, it is desirable to prepare in advance various kinds of torpedo plates in accordance with the variety of resin materials so that they can be exchanged.

The torpedo plates 13 can be exchanged only by mounting and demounting the bolts 15 from the outside of the plasticizing cylinder 10, which is easier compared with exchange of the screws. Therefore, operation of adjustment to obtain the optimum plastication states for the respective resin materials (i.e., the exchange of the torpedo plates) can be conducted in a short period of time, ensuring efficiency in adjustment operation of an injection molding machine or an extrusion molding machine.

Further, since such a member as the torpedo plate is generally low in cost compared with the screw, costs for equipment can be curbed even though a plurality of torpedo plates are prepared in accordance with the variety of resin materials to be plasticized when compared with a case where a plurality of screws are prepared in accordance with the variety of resin materials.

In addition, shown in FIG. 5 is the configuration in which one piece of torpedo plate is installed; however, the configuration may be arranged such that a plurality of torpedo plates are installed. For example, a plurality of torpedo plates which are different in the number of, or in the positions of fins for supporting the torpedoes are employed in combination to provide the fins with a function of a static mixer. Accordingly, combining a plurality of torpedo plates having different structures also provides another advantage than the uniform plastication of the molten resin.

Incidentally, in the configuration described above, the torpedo plate is installed between the nozzle and the plasticizing cylinder; however, if performing extrusion molding using a cross head, the configuration may be arranged such that the torpedo plate is installed between the plasticizing cylinder and the cross head. In addition, the resin material applicable is not limited to, for example, the polybutylene telephthalate, the polypropylene and the commonly-used thermoplastic elastomer which are described in the embodiments.

The foregoing description of the preferred embodiments of the invention has been presented for purposes of illustration and description; however, it is not intended to limit the invention to the preferred embodiments, and modifications and variations are possible as long as they do not deviate from the principles of the invention.

1. A screw for plastication of resin material installed in a plasticizing cylinder for plasticizing a resin material for molding, wherein
an external diameter D of a metering section formed at a top part of the screw is 100 mm or less,
an L/D ratio obtained by dividing a length L of a section of the screw on an outer surface of which a spiral screw flight is formed by the external diameter D of the metering section is 10 or less, and
a pitch of the screw flight is designed so that a thread length thereof falls within a range of 30 to 300% of a thread length of a screw in which an L/D ratio is 20 to 24 and a pitch of a screw flight is designed to be the same as an external diameter D of a metering section.

2. The screw for plastication of resin material according to claim 1, wherein
an external diameter of a feed section for feeding the resin material into the plasticizing cylinder is designed to be larger than the external diameter of the metering section for keeping an extrusion amount of the resin material uniform and an external diameter of a compression section for plasticizing the resin material, and
a channel depth of the feed section formed by the screw flight is designed to be larger than a channel depth of the compression section.

3. The screw for plastication of resin material according to claim 1, wherein
a pitch of the screw flight in the feed section for feeding the resin material into the plasticizing cylinder is designed to be larger than a pitch of the screw flight in the metering section for keeping the extrusion amount of the resin material uniform and smaller than the external diameter of the metering section, and
a pitch of the screw flight in the compression section for plasticizing the resin material is designed to become smaller gradually from the feed section toward the metering section.

4. The screw for plastication of resin material according to claim 3, wherein
the pitch of the screw flight in the feed section for feeding the resin material into the plasticizing cylinder is designed to be more than 1.5 times as large as the pitch of the screw flight in the metering section for keeping the extrusion amount of the resin material uniform.

5. A plasticizing mechanism for resin material, wherein the screw for plastication of resin material according to claim 1 is installed in the plasticizing cylinder for plasticizing the resin material, and
a torpedo plate, in which a torpedo is supported so as to be positioned in a central part of a path of the resin material, is arranged to be mountable and demountable at a downstream part of a flow of the resin material in the plasticizing screw, and the resin material inside the plasticizing cylinder is conveyed to flow around the torpedo in the torpedo plate.

6. The screw for plastication of resin material according to claim 2, wherein
a pitch of the screw flight in the feed section for feeding the resin material into the plasticizing cylinder is designed to be larger than a pitch of the screw flight in the metering section for keeping the extrusion amount of the resin material uniform and smaller than the external diameter of the metering section, and
a pitch of the screw flight in the compression section for plasticizing the resin material is designed to become smaller gradually from the feed section toward the metering section.

7. A plasticizing mechanism for resin material, wherein
the screw for plastication of resin material according to claim 2 is installed in the plasticizing cylinder for plasticizing the resin material, and
a torpedo plate, in which a torpedo is supported so as to be positioned in a central part of a path of the resin material, is arranged to be mountable and demountable at a downstream part of a flow of the resin material in the plasticizing screw, and the resin material inside the plasticizing cylinder is conveyed to flow around the torpedo in the torpedo plate.

8. A plasticizing mechanism for resin material, wherein
the screw for plastication of resin material according to claim 3 is installed in the plasticizing cylinder for plasticizing the resin material, and
a torpedo plate, in which a torpedo is supported so as to be positioned in a central part of a path of the resin material, is arranged to be mountable and demountable at a downstream part of a flow of the resin material in the plasticizing screw, and the resin material inside the plasticizing cylinder is conveyed to flow around the torpedo in the torpedo plate.

9. A plasticizing mechanism for resin material, wherein
the screw for plastication of resin material according to claim 4 is installed in the plasticizing cylinder for plasticizing the resin material, and
a torpedo plate, in which a torpedo is supported so as to be positioned in a central part of a path of the resin material, is arranged to be mountable and demountable at a downstream part of a flow of the resin material in the plasticizing screw, and the resin material inside the plasticizing cylinder is conveyed to flow around the torpedo in the torpedo plate.
